(19) United States
(12) Patent Application Publication
(10) Pub. No.: US 2023/0328132 A1
(43) Pub. Date: Oct. 12, 2023

(54) SYSTEM AND METHOD FOR MIDSERVER INTEGRATION AND TRANSFORMATION OF TELEMETRY FOR CLOUD - BASED SERVICES

(71) Applicant: QOMPLX, Inc., Tysons, VA (US)

(72) Inventors: Jason Crabtree, Vienna, VA (US); Richard Kelley, Woodbridge, VA (US)

(21) Appl. No.: 18/186,605

(22) Filed: Mar. 20, 2023

Related U.S. Application Data
(63) Continuation-in-part of application No. 18/146,966, filed on Dec. 27, 2022.
Application No. 18/146,966 is a continuation-in-part of application No. 16/412,340, filed on May 14, 2019, now Pat. No. 11,539,663.
Application No. 16/412,340 is a continuation-in-part of application No. 16/267,893, filed on Feb. 5, 2019, now abandoned.
Application No. 16/267,893 is a continuation-in-part of application No. 16/248,133, filed on Jan. 15, 2019, now abandoned.
Application No. 16/248,133 is a continuation-in-part of application No. 15/849,901, filed on Dec. 21, 2017, now Pat. No. 11,023,284.
Application No. 15/849,901 is a continuation-in-part of application No. 15/835,436, filed on Dec. 7, 2017, now Pat. No. 10,572,828.
Application No. 15/849,901 is a continuation-in-part of application No. 15/835,312, filed on Dec. 7, 2017, now Pat. No. 11,055,451.
Application No. 16/248,133 is a continuation-in-part of application No. 15/813,097, filed on Nov. 14, 2017, now abandoned.
Application No. 16/248,133 is a continuation-in-part of application No. 15/806,697, filed on Nov. 8, 2017, now abandoned.
Application No. 15/835,436 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 16/248,133 is a continuation-in-part of application No. 15/673,368, filed on Aug. 9, 2017, now abandoned.
Application No. 15/790,327 is a continuation-in-part of application No. 15/616,427, filed on Jun. 7, 2017, now abandoned.
Application No. 15/813,097 is a continuation-in-part of application No. 15/616,427, filed on Jun. 7, 2017, now abandoned.
Application No. 15/806,697 is a continuation-in-part of application No. 15/376,657, filed on Dec. 13, 2016, now Pat. No. 10,402,906.
Application No. 15/673,368 is a continuation-in-part of application No. 15/376,657, filed on Dec. 13, 2016, now Pat. No. 10,402,906.
Application No. 15/806,697 is a continuation-in-part of application No. 15/343,209, filed on Nov. 4, 2016, now Pat. No. 11,087,403.
Application No. 15/376,657 is a continuation-in-part of application No. 15/237,625, filed on Aug. 15, 2016, now Pat. No. 10,248,910.
Application No. 15/343,209 is a continuation-in-part of application No. 15/237,625, filed on Aug. 15, 2016, now Pat. No. 10,248,910.
Application No. 15/343,209 is a continuation-in-part of application No. 15/229,476, filed on Aug. 5, 2016, now Pat. No. 10,454,791.
Application No. 15/237,625 is a continuation-in-part of application No. 15/206,195, filed on Jul. 8, 2016, now abandoned.
Application No. 15/229,476 is a continuation-in-part of application No. 15/206,195, filed on Jul. 8, 2016, now abandoned.
Application No. 15/835,312 is a continuation-in-part of application No. 15/186,453, filed on Jun. 18, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/790,327 is a continuation-in-part of application No. 15/141,752, filed on Apr. 28, 2016, now Pat. No. 10,860,962.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/141,752 is a continuation-in-part of application No. 14/986,536, filed on Dec. 31, 2015, now Pat. No. 10,210,255.
Application No. 15/616,427 is a continuation-in-part of application No. 14/925,974, filed on Oct. 28, 2015, now abandoned.
Application No. 15/141,752 is a continuation-in-part of application No. 14/925,974, filed on Oct. 28, 2015, now abandoned.
(60) Provisional application No. 62/568,291, filed on Oct. 4, 2017.
(60) Provisional application No. 62/568,298, filed on Oct. 4, 2017.

(51) Int. Cl. H04L 67/10

(52) U.S. Cl. CPC H04L 67/10

(57) ABSTRACT

A system and method that uses midservers located between the business enterprise computer infrastructure and the cloud-based infrastructure to collect, aggregate, analyze, transform, and securely transmit data from a multitude of computing devices and peripherals at an external network to a cloud-based service. The system and method make use of a plurality of virtual and physical worker agents which can be dynamically instantiated by a transformation engine to carry out one or more transformation sequences, based on pipeline instructions, to a received data stream to prepare the data for transmission as a target data stream format.

### CROSS-REFERENCE TO RELATED APPLICATIONS

Priority is claimed in the application data sheet to the following patents or patent applications, each of which is expressly incorporated herein by reference in its entirety:
18/146,966
16/412,340
16/267,893
16/248,133
15/813,097
15/616,427
14/925,974
15/806,697
15/376,657
15/237,625
15/206,195
15/186,453
15/166,158
15/141,752
15/091,563
14/986,536
15/343,209
15/229,476
15/673,368
15/849,901
15/835,312
15/835,436
15/790,457
62/568,298
15/790,327
62/568,291

### BACKGROUND OF THE INVENTION

### Field of the Art

The disclosure relates to the field of computer technology, more specifically to the field of computer architectures for enterprise data collection, analysis, transformation, and transmission to cloud-based services.

### Discussion of the State of the Art

As cloud-based computing services become more popular, management of the data collection from a business and transmission of that data to a cloud-based service become more complicated. Large business enterprises can have thousands of computers and peripherals, many of which are now mobile devices. Collection, management, and security of data from those many devices becomes particularly important where data is being transferred to a cloud-based service.

When a large business enterprise uses a cloud-based computing service, heterogeneous data transfer between cloud services and large offices or campuses for organizations presents numerous problems, including lack of reliable data collection methods, poor standardized support for connection-oriented protocols by network appliances, security concerns with unfiltered or poorly filtered data, and bandwidth concerns with constantly streaming data which may result in network slowdown due to unprioritized data transfer. Additionally, larger business enterprises may have thousands of computing devices sending data to a cloud-based service on separate connections, and each such connection represents an additional security risk. Further, current data collection and models do not scale well for adding new data sources and flexible adhoc queries, resulting in too much data being passed, no context for data and data sources oftentimes, unqueryable data and data sources, inability to flexibly and quickly add new data sources such as new devices or user accounts which generate new data for analysis, and log management and data storage become expensive and disorganized.

The problem is compounded by the use of black box threat detection methods, where data management and security optimization are not possible for each organization or user of a cloud-based service. Particularly in the context of data ingestion systems, it is often unclear from a data stream what portion of the data results in triggering of certain security alerts, requiring many costly hours of analytics at best, or resulting in missed errors or security concerns at worst.

What is needed is a computer architecture and methodology that allows for collection, aggregation, analysis, transformation, and secure transmission of data from a multitude of computing devices and peripherals at a business enterprise network to a cloud-based service.

### SUMMARY OF THE INVENTION

Accordingly, the inventor has conceived, and reduced to practice, a system and method that uses midservers located between the business enterprise computer infrastructure and the cloud-based infrastructure to collect, aggregate, analyze, transform, and securely transmit data from a multitude of computing devices and peripherals at an external network to a cloud-based service. The system and method make use of a plurality of virtual and physical worker agents which can be dynamically instantiated by a transformation engine to carry out one or more transformation sequences, based on pipeline instructions, to a received data stream to prepare the data for transmission as a target data stream format. The following non-limiting summary of the invention is provided for clarity, and should be construed consistently with embodiments described in the detailed description below.

According to a preferred embodiment, a system for ingestion and transformation of data into a cloud-based service from an external network is disclosed, comprising: a midserver comprising at least a processor, a memory, and a plurality of programming instructions stored in the memory and operating on the processor, wherein the plurality of programming instructions, when operating on the processor, cause the processor to: receive a data stream over a local network from a plurality of computing devices; determine a target data stream format; determine a transformation sequence for the received data stream based at least on the determined target data stream format; break the data stream into one or more work units; assign the one or more work units to a worker agent for transformation; wherein the worker agent is configured to: for each work unit, apply a plurality of transformations to at least a portion of the work unit; and return each transformed work unit; append each transformed work unit into a single transformed data stream; and retransmit the received data stream over a secure connection as a single transformed data stream.

According to another preferred embodiment, a method for ingestion and transformation of data into a cloud-based service from an external network, comprising the steps of: receiving a data stream over a local network from a plurality of computing devices; determining a target data stream format; determining a transformation sequence for the received data stream based at least on the determined target data stream format; breaking the data stream into one or more work units; assigning the one or more work units to a worker agent for transformation; wherein the worker agent is configured to perform the steps of: for each work unit, applying a plurality of transformations to at least a portion of the work unit; returning each transformed work unit; appending each transformed work unit into a single transformed data stream; and retransmitting the received data stream over a secure connection as a single transformed data stream.

According to an aspect of an embodiment, the determination of the target data stream format is based at least on a destination system or service, on an intended use, or based on metadata.

According to an aspect of an embodiment, the metadata includes at least an indication of where each data element of the data stream came from and an indication of when each data element was received.

According to an aspect of an embodiment, the transformation sequence identifies one or more transformations needed for each data element of the received data stream and identifies the order in which the one or more transformations need to be performed.

According to an aspect of an embodiment, the work units are divided by selecting from the group consisting of based on unit size, based on type of transformation needed, and based on data source attributes.

According to an aspect of an embodiment, the worker agent is a virtual agent operating within the midserver.

According to an aspect of an embodiment, the worker agent is a physical agent operating on a network device separate from the midserver.

According to an aspect of an embodiment, the worker agent comprise both virtual agents and physical agents.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary midserver system architecture.

FIG. 2 is a diagram of an exemplary midserver architecture showing data input to a midserver and the ingestion of forwarded data from a midserver through a proxy to a cloud service.

FIG. 3 is a diagram of an exemplary midserver architecture between multiple office locations.

FIG. 4 is diagram of another exemplary midserver architecture between multiple office locations.

FIG. 5A is a partial diagram of an exemplary advanced cyber-decision platform utilizing midserver architecture.

FIG. 5B is a partial diagram of an exemplary advanced cyber-decision platform utilizing midserver architecture.

FIG. 5C is a partial diagram of an exemplary advanced cyber-decision platform utilizing midserver architecture.

FIG. 6 is a diagram showing an exemplary architecture and methodology for midserver deployment, automated onboarding of data, and endpoint transparent data transport.

FIG. 7 is an exemplary method for deploying a midserver where the business enterprise network is located on, or utilizes, a cloud computing service such as Amazon Web Services (AWS) or Microsoft’s Azure.

FIG. 8 is another exemplary method for deploying a midserver where the business enterprise network is located on, or utilizes, a cloud computing service such as Amazon Web Services (AWS) or Microsoft’s Azure.

FIG. 9 is a diagram showing an overview of the methodology of two of several known Kerberos attacks.

FIG. 10 is a diagram showing an overview of the use of a ledger of Kerberos requests and responses to provide security against Kerberos attacks.

FIG. 11A is a partial diagram of an exemplary analytic workflow for validation of a Kerberos ticket-based security protocol for use in an observed system.

FIG. 11B is a partial diagram of an exemplary analytic workflow for validation of a Kerberos ticket-based security protocol for use in an observed system.

FIG. 12 is a block diagram illustrating an exemplary system architecture for a midserver configured for data stream ingestion and transformation, according to an embodiment.

FIG. 13 is a flow diagram illustrating an exemplary method performing a data stream transformation using midserver system, according to an embodiment.

FIG. 14 is a block diagram illustrating an exemplary hardware architecture of a computing device.

FIG. 15 is a block diagram illustrating an exemplary logical architecture for a client device.

FIG. 16 is a block diagram showing an exemplary architectural arrangement of clients, servers, and external services.

FIG. 17 is another block diagram illustrating an exemplary hardware architecture of a computing device.

### DETAILED DESCRIPTION OF THE DRAWING FIGURES

The inventor has conceived, and reduced to practice, a system and method that uses midservers located between the business enterprise computer infrastructure and the cloud-based infrastructure to collect, aggregate, analyze, transform, and securely transmit data from a multitude of computing devices and peripherals at an external network to a cloud-based service. The system and method make use of a plurality of virtual and physical worker agents which can be dynamically instantiated by a transformation engine to carry out one or more transformation sequences, based on pipeline instructions, to a received data stream to prepare the data for transmission as a target data stream format.

One method of data collection from large business enterprises for cloud-based computing is through agent based monitoring. In agent-based monitoring, software “agents” are installed on each computing device to collect data and then forward the data to the cloud-based service. Using agent-based monitoring, it may be necessary to install hundreds or thousands of agents on an external network to collect the required data. Each of these agents, in turn, establish an outgoing network connection to provide data to the cloud-based service. While secure transport protocols such as TLS can ensure data security, the overall number of connections to monitor at the business network edge increases substantially. This causes even more noise for network defenders to sift through. By aggregating data at midservers multiple connections can be presented over the network as a single secure connection to enterprise cloud-based systems (wlog using standard VPN or similar encryption-based network transport technologies). Thousands of connections from a large business enterprise can be reduced to a single connection or a small number of connections. It should be noted that another method of gathering data from a business enterprise network is through port mirroring. The terms “agent” and “port mirroring” are exemplary only, and do not exclude other methods of gathering data from a business enterprise network.

Midserver architecture also solves the problem that not all devices support secure data transport. For example, many devices do not natively support sending system log messages using TLS. In order to support system log traffic the data must be wrapped in a secure protocol before leaving the network. A midserver can provide this type of capability by collecting and wrapping the data before it leaves the network.

Midservers can optimize the ingestion of data into the cloud-based service by transforming the data prior to forwarding upstream. It is possible to process the data on the external network computers using an agent or additional software, but this adds complexity to the agent or requires more software installed on customer site. A midserver can act as a local processing station (often called “pre-processing”) for data transformations such as compression, protocol wrapping, port bending, and many others.

Midservers can be used to prevent data loss during transmission, especially for network data that is transitory in nature. For many protocols the sender/receiver can adjust for a degraded connection without any loss of data integrity. Additionally, in some other cases the originating message can be reproduced meaning that a loss of data has little impact on the capability. For example, some agents query the current state of the system and then forward the results to a fleet manager. If the results are somehow lost during transit it is possible to issue the same query and try again. However, other data sources such as network packet captures are much less forgiving. Systems that capture ephemeral network traffic are especially impacted by data lost in transit. A midserver can mitigate this risk by providing traffic buffering in the event that the backhaul connection goes down. When the connection is reestablished, the buffers will empty and continue forwarding as usual.

The midserver architecture may be designed to operate as a bastion host that runs a collection of containerized services. It is assumed that midservers are cyber security targets and are likely to be compromised at some point. Ideally, therefore, the midserver should be designed to reduce data loss and further access to the enterprise network to which it is attached. Midservers should not be a primary data store, and should only buffer data when connections are lost. Midservers should have only the minimum software necessary to operate, and least privilege should be enforced for access. Midservers may be configured as a single server instance or as a clusters of redundant servers to provide additional resiliency.

The midserver runs a plurality of containerized services that serve to collect, aggregate, analyze, transform, and securely transmit data. The containerized service run by the midserver can be roughly categorized in four ways: traffic processors, sensors, management services, and utilities.

Containers acting as traffic processors are primarily used to receive forwarded traffic from a customer network, transform the traffic if necessary, and then forward the traffic upstream over the primary connection. Several examples of traffic processing containerized services are: reverse proxy containers, system log containers, and messaging containers. An example of a reverse proxy containerized service is Nginx. The Nginx proxy (nginx-pxy) provides reverse proxy capabilities that allows customer traffic to send approved data through the midserver. Data and log sources that support the proxy protocol will connect to this service. The service also provides traffic transform capabilities such as http to https forwarding and others as supported by Nginx. In a system log containerized service, the service provides log consolidation and forwarding capabilities for logs sent using the system log protocol. The service also provides message shaping and enrichment such as adding additional contextual fields to log sources if needed. An example of a messaging containerized service is RabbitMQ. The RabbitMQ service acts as a proxy for advanced messaging queueing protocol (AMQP) messages using the Shovel plugin. The service is primarily used for queuing and forwarding of traffic generated by messaging agents, and can support any AMQP traffic as needed. Another traffic processing containerized service example is Consul, which provides service discovery and is may be used to support RabbitMQ configurations in a midserver cluster.

Containers acting as sensors can monitor and generate data rather than just process data from other sensors or data sources.

Management containers are used for providing management consoles or services for midserver administrators. Examples of management containers include the Nginx management proxy and Portainer. The Nginx management proxy (nginx-mgt) is responsible for managing connections to management interfaces on containers. This containerized service acts a firewall to only allow traffic to management pages and services originating from approved address spaces. Portainer provides a lightweight management UI which allows administrators to easily manage and monitor the other container services on the midserver.

Utility containers are special purpose tools used to aid in configuration or deployment of a midserver.

Consolidating these containerized services at the midserver allows for large-scale, reliable ingestion (i.e., one or more of collection, aggregating, analysis (pre-processing), transformation (pre-processing), and secure transmission) of data into a cloud-based service from an external network. This improves data consistency, reliability, efficiency of bandwidth usage, and security. Using the midserver as a gateway to the cloud-based service dramatically reduces the number of connections at the business enterprise’s network edge, greatly reducing the number of avenues of attack and improving network security.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way.

One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Bastion host” as used herein means a computer that is deliberately exposed on a public network as the primary or only node or the network exposed to the outside world. A bastion host processes and filters all incoming traffic and prevents malicious traffic from entering the network.

“Ingestion” as used herein means the transfer of data into a cloud-based service.

“Midserver” as used herein means a server that functions as an interface between an external network and a cloud-based service, and which runs one or more containerized services that perform one or more of: collecting, aggregating, analyzing, filtering, transforming, and securely transmitting data. A midserver may also be configured as a bastion host.

### Conceptual Architecture

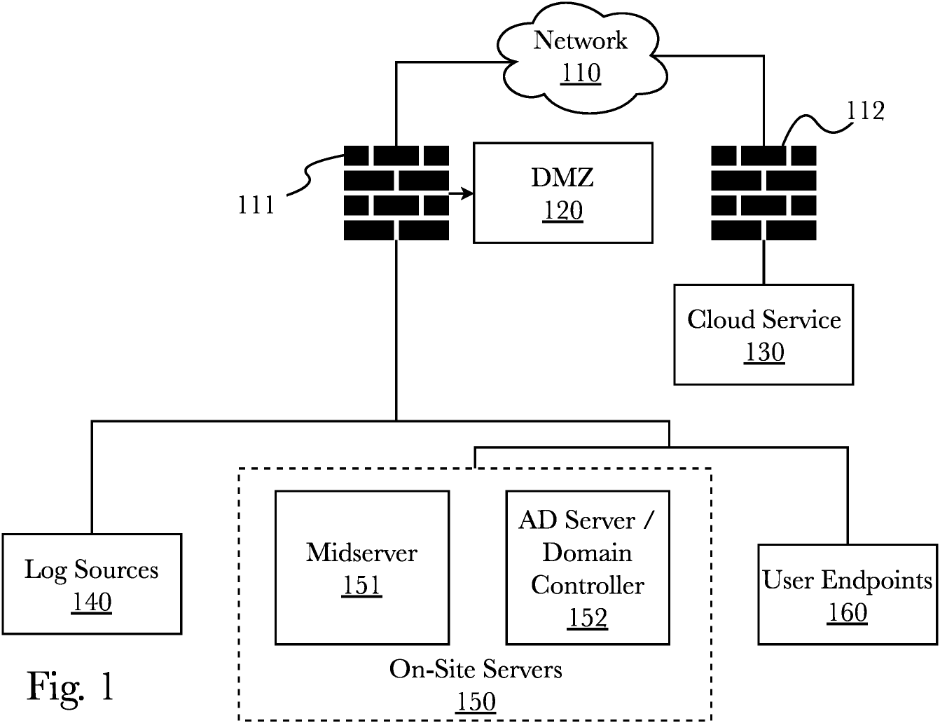

FIG. 1 is a diagram of an exemplary midserver system architecture. A network 110 exists connecting a cloud service 130, through a firewall or security layer 112, as well as an on-site security layer or firewall 111 with some organization which may wish to connect over a network 110 to a cloud service 130. A demilitarized zone (“DMZ,” also known as a perimeter network or screened subnet) 120 is present which may present the forward-facing network connections and functionality of an organization’s network or services, which may be forwarded data or interface further with on-site servers 150 and user endpoints 160, or data log sources 140. On-site servers 150 may include a midserver 151 for collecting, aggregating, analyzing, filtering, transforming, and securely transmitting data transfers and interactions with a cloud service 130, typically co-located with the enterprise domain controller ( or Active Directory (AD) server) 152 for exploration of network-enabled directories and to control access to and authenticate security requests on the network for other connected servers 150. A midserver 151 in this implementation may be used for streamlined communications with a cloud service 130 including a single point of connectivity with the service, a ticket form of security adding further security to such a connected system, and a batch method of data transfer, allowing numerous other servers 150 or endpoints 160 or log sources 140 to communicate with the midserver which then collates data for transfer to a cloud server 130, which may further collate data received from the cloud service 130, for ease of analysis and which allows for other forms of network optimization to take place which are not present in systems where numerous endpoints and servers maintain individual connections to a cloud service 130, also allowing for new data sources including servers 150 and endpoints 160 to be added swiftly and integrated into the system for connection to the cloud service 130 rapidly and easily due to the midserver 151 acting as an interface between the service 130 and the other possible endpoint 160 or server 150.

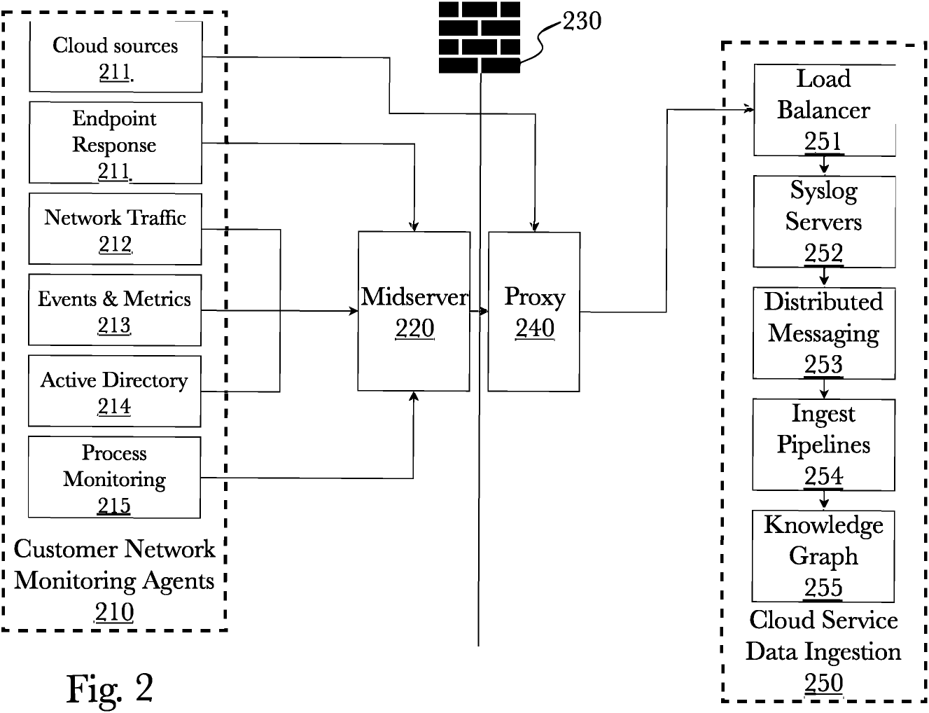

FIG. 2 is a diagram of an exemplary midserver architecture showing data input to a midserver and the ingestion of forwarded data from a midserver through a proxy to a cloud service. Cloud sources 211 of customer monitoring agents 210 may provide input to a proxy server 240 behind a firewall 230 which filters data going in and out of an organization’s network. These sources of customer network monitoring agents 210 may include data that is gathered from online tools such as social media crawlers or any other source of customer network monitoring from a cloud service or network 211. On-site data monitoring tools and processes include endpoint responses 211, network traffic data 212, events and metrics 213 which may include metadata about devices, users, or other connected assets, active directory 214 usage, and process monitoring 215 which may monitor active processes on connected assets such as operations performed on a connected network endpoint such as a computer workstation. Data from these sources is sent to a midserver 220 which may be on-site or connected to via a Virtual Private Network (VPN), before the data is sent to through an organizations firewall 230 to a proxy server 240, to be forwarded to a cloud service’s data ingestion pipeline 250. Such a data ingestion pipeline 250 may include the use of a load balancer 251 to aid in processing of received data loads from differing sources, system log servers 252 which may record the reception and content of data or any other metadata about the connection to a proxy server 240 and the activity of the load balancer 251, before forwarding data to a distributed messaging system 253 which may separate received data and data streams into related “topics” which may be defined by the sender’s identity, metadata about the streams or batches of data, or some other qualifier. Ingestion pipelines 254 may process data by filtering, mapping, parsing, and sanitizing data received, before adding it to a temporal knowledge graph 255 representing a graph of assets, people, events, processes, services, and “tickets” of concerns, as well as data about the edges connecting such nodes in the graph such as their relationship, over time.

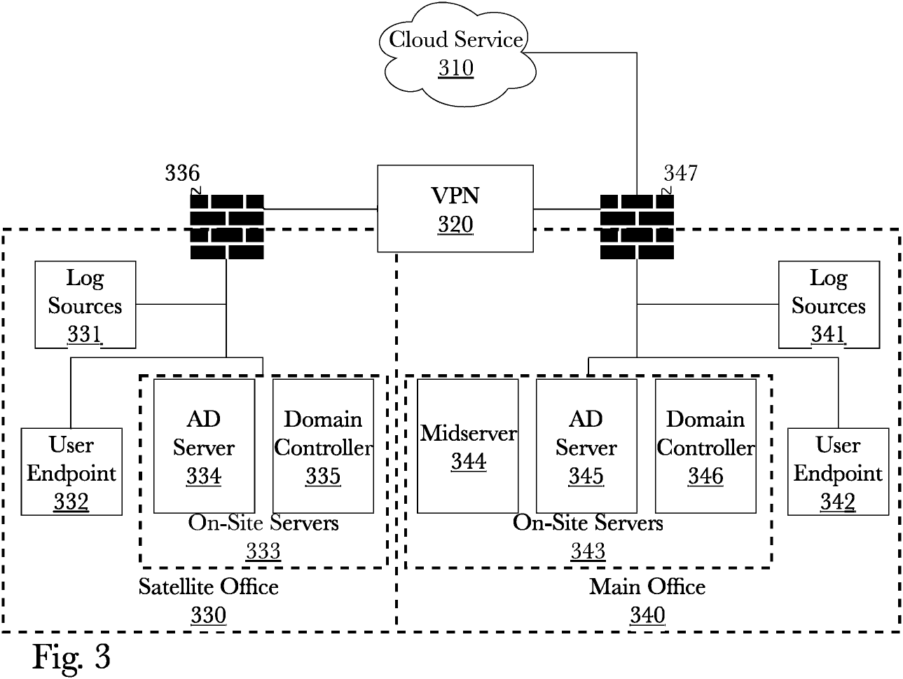

FIG. 3 is a diagram of an exemplary midserver architecture between multiple office locations. A cloud service 310 exists which connects to a main office 340 but not a satellite office 330 over a network such as the Internet, with a VPN 320 connected between the networks of the offices. A satellite office 330 contains numerous assets including log sources 331, user endpoints 332, and a server or servers 333 which include the functionality of an Active Directory (AD) server 334 and domain controller 335. Also operating on a satellite office 330 is firewall 336, in addition to firewall on a main office’s network 347, which provides basic security to a satellite office’s network 330 and a main office’s network 340. Connected via a VPN 320 with a satellite office 330 is a main office 340, which comprises many of the same components, including log sources 341, at least one user endpoint 342, and a group of servers 343 including at least an AD server 345 and domain controller 346, as well as a midserver 344, which may communicate with a satellite office 330 to provide access to midserver functionality without using the satellite office’s 330 bandwidth to external networks. Midservers 344 may be deployed as a single instance, or as a cluster depending on the traffic volume leaving the office 340 premise to support high availability operational requirements. These servers may be co-located with the domain controllers 346 and other servers 343, but may be placed anywhere on the network. The exact number and configuration of midservers 344 may be tailored to the organizational environment and the specific overall network architecture. It is possible to place a midserver 344 (or cluster of such) at the main office 340 only, as shown in FIG. 3. In this configuration, the agents (or log source 331) installed at the satellite office 330 will forward all traffic across the VPN connection 320 to the Midserver 344 at the Main Office 340, which will then forward the traffic to the cloud infrastructure 310 via the gateway at that location.

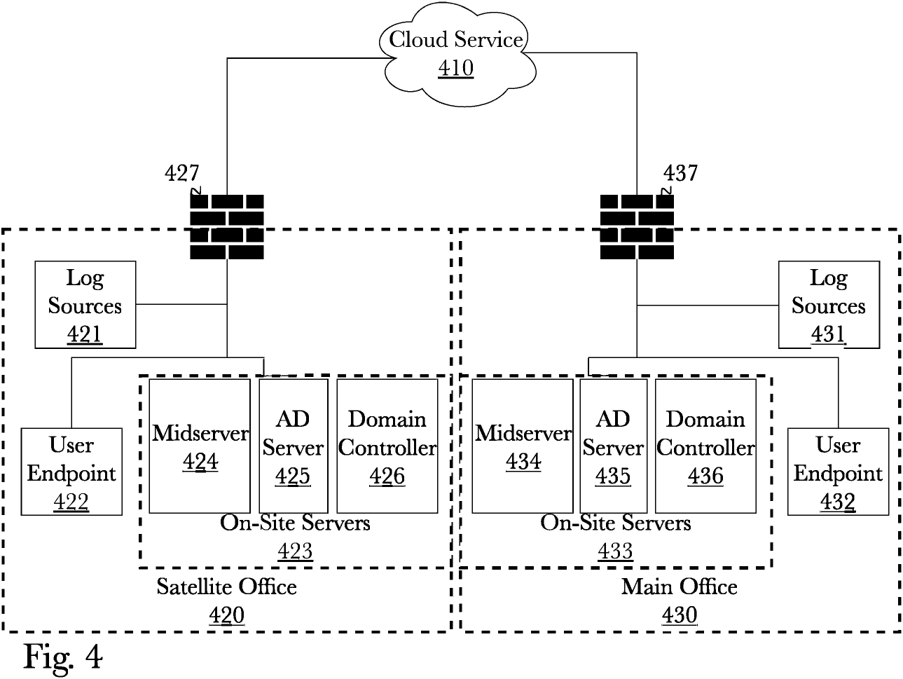

FIG. 4 is diagram of another exemplary midserver architecture between multiple office locations. An alternative configuration compared to FIG. 3 is shown, placing one or more midservers at the satellite office and allowing traffic to egress the network locally instead of through a VPN connection to other locations. A cloud service 410 exists which connects directly to a main office 430 and a satellite office 420 over a network such as the Internet. A satellite office 420 contains numerous assets including log sources 421, user endpoints 422, and a server or servers 423 which include the functionality of a midserver 424, an Active Directory (AD) server 425, and a domain controller 426. Also operating on a satellite office 420 is firewall 427, in addition to firewall on a main office’s network 437, which provides basic security to a satellite office’s network 420 and main office network 430. Connected also with a cloud service 410 is a main office network 430, which comprises many of the same components, including log sources 431, at least one user endpoint 432, and a group of servers 433 including at least an AD server 435 and domain controller 436, as well as a midserver 434, allowing for both office networks 420, 430 to have midserver functionality without requiring a direct or virtual connection.

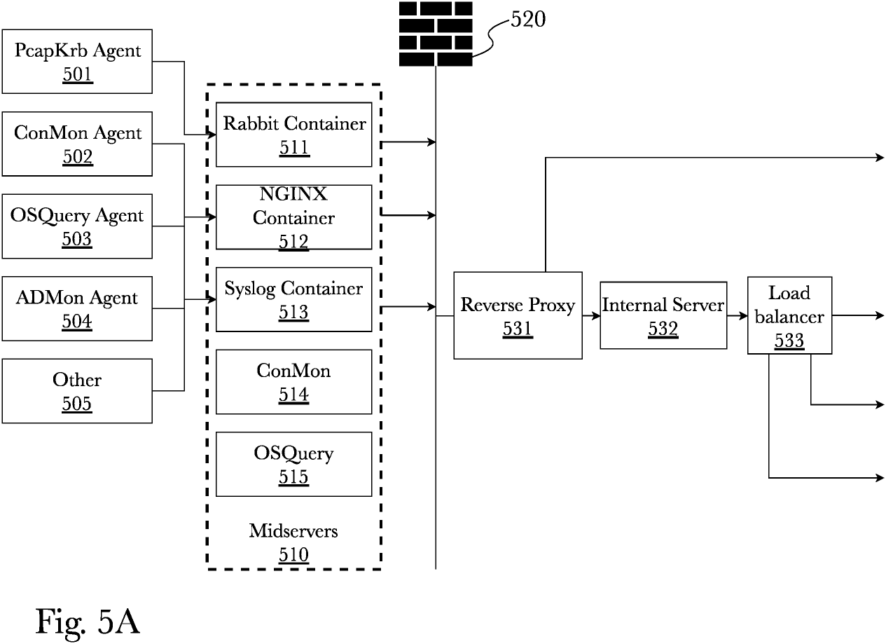

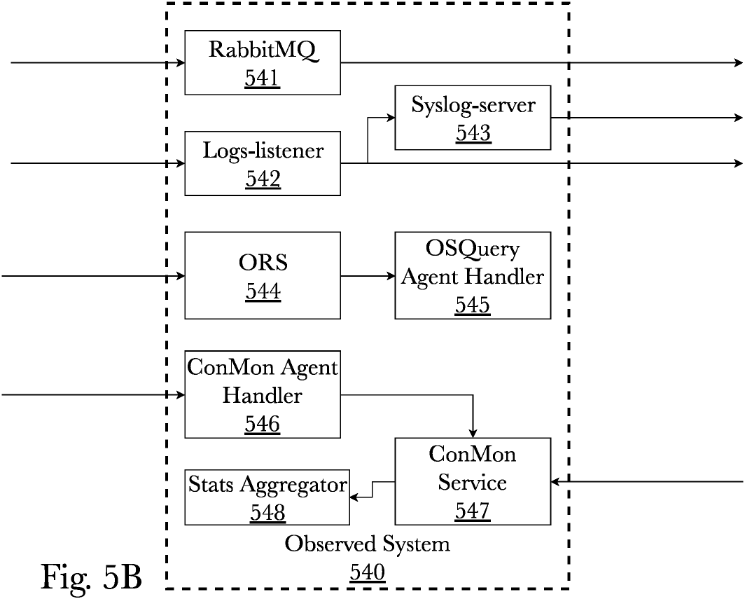

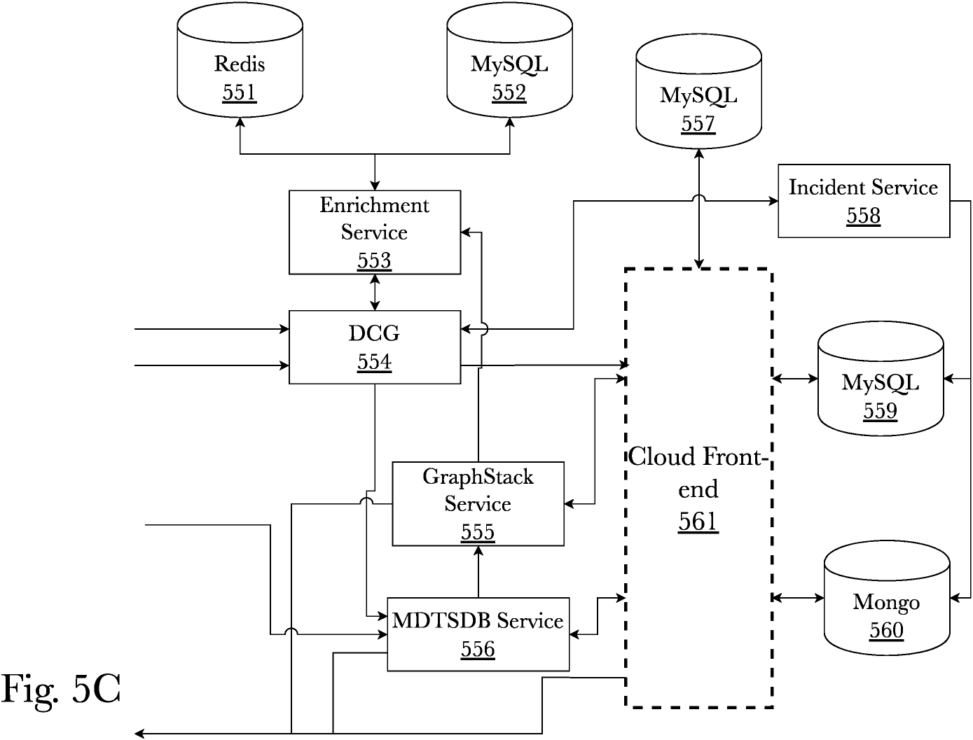

FIG. 5A is a partial diagram of an exemplary advanced cyber-decision platform utilizing midserver architecture. A plurality of software agents may monitor an organization’s network usage, including but not limited to a Kerberos messaging capture (PcapKrb) agent 501 continuous monitoring (Application Performance Monitoring) agents 502, Osquery agents 503, active directory monitoring (ADMon) agents 504, and other agents 505 which may include, for example, data received from system log (syslog) data stores. The plurality of network monitoring agents may feed into a midserver or midservers 510 that may contain message and data processing containerized services, for example: a RabbitMQ container 511, an NGINX container 512, a system log container 513, a continuous monitoring module 514, an Osquery engine 515. The midserver 510 may communicate through a network firewall 520, to a reverse proxy 531 which may mask the external-facing properties of an internal server 532 of a cloud service. A reverse proxy 531 may forward relevant data, or all data, received from a midserver 510, to an internal server 532, which utilizes a load balancer 533 to process data efficiently and effectively despite possibly asymmetrical or massive network loads, or dynamically changing loads.

FIG. 5B is a partial diagram of an exemplary advanced cyber-decision platform utilizing midserver architecture. An observed system 540 is a system that is monitored by an exemplary advanced cyber-decision platform that may communicate with a midserver 510, and may contain at least a message digestion and management service such as RabbitMQ 541, a log listener 542 which communicates with a system log server 543 for the purpose of managing, monitoring, and storing system logs. An observed system may also include an Observer Reporting Server (ORS) 544, which may communicate with an Osquery Agent Handler 545, allowing management, recording, and monitoring of users and systems who use Osquery or a similar system to query a device or server similarly to a database, as is the purpose of Osquery. Also present is a ConMon Agent Handler 546 which my operate as an interface to continuous monitoring connected systems, acting as an interface for a ConMon service 547, which receives further input from systems illustrated in FIG. 5C and may communicate with a statistics aggregator 548.

FIG. 5C is a partial diagram of an exemplary advanced cyber-decision platform utilizing midserver architecture. Data flows from an observed system 540 into a directed computational graph (DCG) 554, and a Multivariate Time-Series Database (MDTSDB) 556. Data from a DCG 554 may move to an enrichment service 553, connected to a plurality of differently structured databases such as MySQL 552 and Redis 551, an enrichment service being able to store and record relevant graph data in these databases 552, 551 and also forward related stored data to a DCG 554, for the purpose of increased accuracy with data processing. A DCG 554 also may send data to a multi-dimensional time series database (MDTSDB) service 556 which relates all received data and records the temporal metadata, resulting in a multidimensional temporal graph with which to relate data, as generated with the help of a graphstack service 555. A graphstack service manages data received from a MDTSDB service 556 and produces the final graph results, with both the results and operation of the MDTSDB 556 and graphstack service 555 being viewable from a cloud service’s front end 561, which may also communicate with a plurality of datastores 557, 559, 560. A graphstack service 555 may also forward data to an enrichment service 553 for storage in the connected databases 551, 552, allowing for a constant stream of graph data to be maintained. Lastly, an incident service 558 may be used to receive incident or error data from a directed computational graph 554, recording these incidents in a plurality of databases 559, 560.

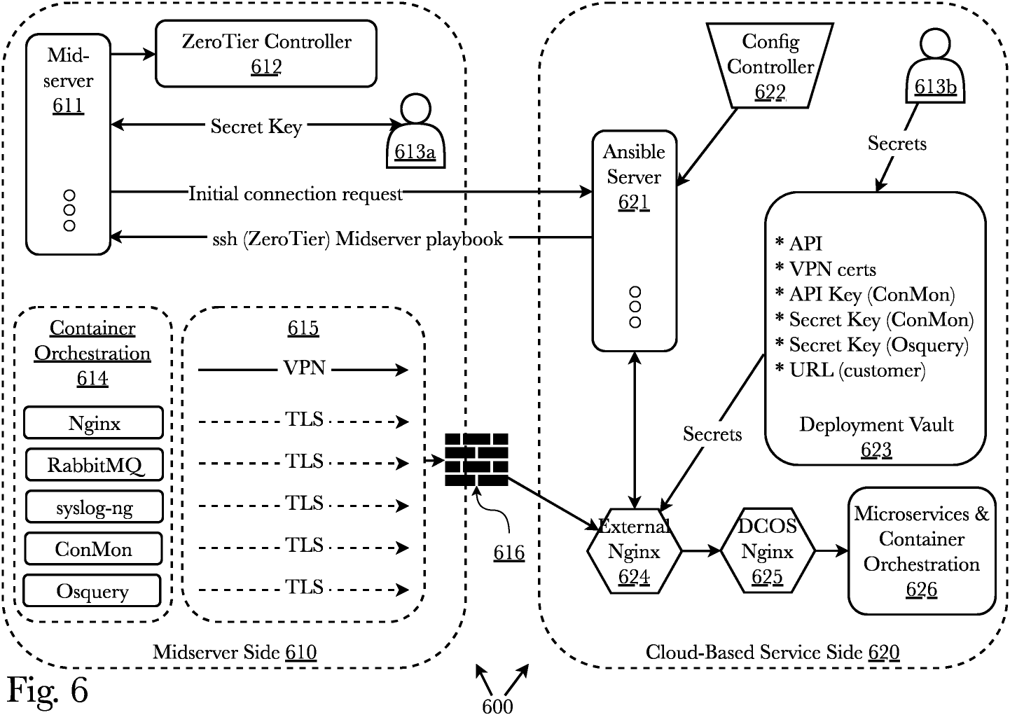

FIG. 6 is a diagram showing an exemplary architecture and methodology 600 for midserver deployment, automated onboarding of data, and endpoint transparent data transport. Midserver deployment comprises establishment of a secure connection between the midserver side 610 and the cloud-based service side 620. After a midserver 611 is physically installed, an automated package called a midserver Open Virtual Appliance (OVA) is installed and run on the midserver 611. The OVA in this example is a virtual image pre-installed with only the minimal software on configurations required to initiate the deployment process. The OVA will initiate a bootstrap process to establish a secure Peer-to-Peer (P2P) connection to the cloud-based service side. Using ZeroTier as an example of a P2P connection, the OVA will initiate a ZeroTier Controller 612, which is responsible for admitting members to the VPN, issuing certificates, and issuing default configuration information. ZeroTier establishes a secure P2P connection over a virtually extensible local area network (VXLAN) called the Reachback Network. Once the initial connection is requested, a representative of the cloud-based service, either onsite 613a or offsite 613b, will verify and approve the connection using a secret key. After a secure connection is established between the midserver and the cloud-based service side at an Ansible server 621, an Ansible playbook is automatically initiated. First, the playbook downloads the most recent configuration template from a configuration controller 622. Next it connects to a deployment vault 623 instance to retrieve the customer specific configurations including any secrets (e.g. passwords, keys, etc.) which will have been previously established by a representative of the cloud-based service 613b. A ZeroTier network application programming interface (API) acts as an adhoc Ansible inventory and a single source of truth for which systems have previously connected to the P2P network. Then, the playbook then begins configurating the midserver 611 via an ssh connection tunnel, establishing a primary backhaul virtual private network (VPN) connection to the cloud-based service. Once this connection is made the midserver tears down the Reachback Network and all communication is done over the VPN through a firewall 616 on the customer network edge. The VPN created using this methodology then allows containerized services 614 to forward data using transport layer security (TLS) 615 to the cloud-based service, allowing for longhaul transportation of data that is transparent to the network endpoint. Some implementations may use external web serving, reverse proxying, caching, and load balancing such as external Nginx 624, data center load balancing and caching such as DCOS Nginx 625, and microservices and container orchestration such as Nginx Plus 626.

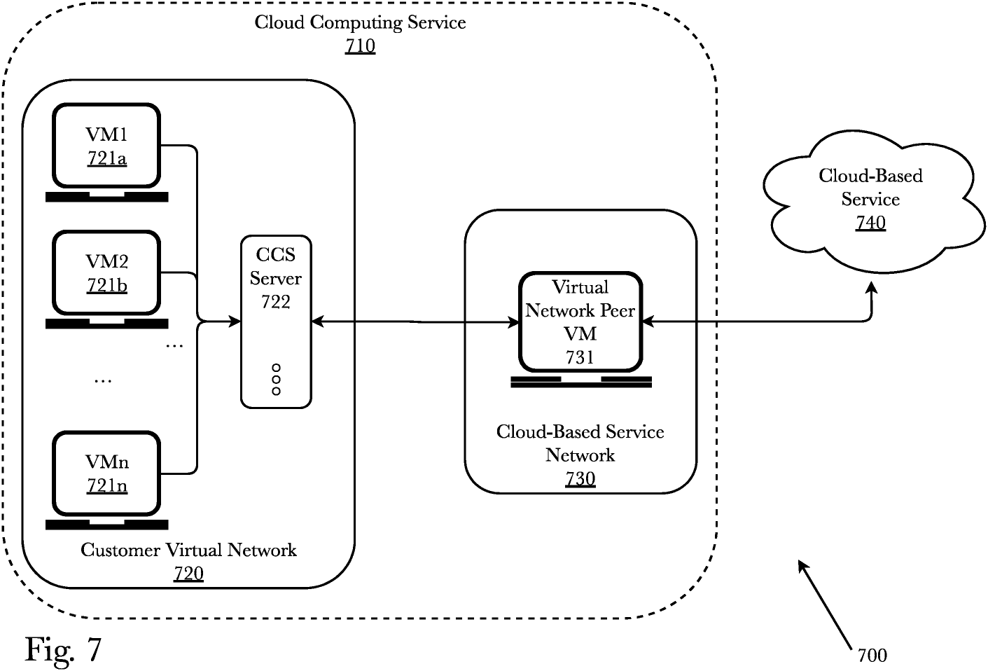

FIG. 7 is an exemplary method 700 for deploying a midserver where the business enterprise network is located on, or utilizes, a cloud computing service such as Amazon Web Services (AWS) or Microsoft’s Azure. In cloud computing services, all or part of the business enterprise’s network is run on the servers of the cloud computing service. Use of midserver architecture where the business enterprise utilizes cloud computing services poses difficulties because the cloud computing service infrastructure is not controlled by the business enterprise, and thus the business enterprise may not be able to authorize the installation of 3^{rd} party software (e.g., Kerberos agents, and other software agents that monitor network traffic) on all or a part of its network. The solution to this problem is to utilize the cloud computing service’s functions that allow continuous streaming of virtual machine network traffic to a network packet collector or analytics tool. Using Microsoft’s Azure Active Directory service and its virtual network terminal access point (vTAP) as an example, the Azure Active Directory (Azure AD) is a cloud-based identity and access management service that allows employees of a business enterprise to access both external and internal resources. The vTAP function allows continuous streaming of cloud computing service network traffic to a network packet collector or analytics tool, and operates in a manner roughly equivalent to traditional port mirroring. Where the business enterprise manages its own network of virtual machines on the cloud computing service, it may still be possible to install software agents, although use of a continuous streaming function may be more efficient. Where the business enterprise uses the cloud computing service for managed domain services, however, the business enterprise does not have authorization to install agents, and the continuous streaming (port mirroring) function will need to be used to deploy a midserver architecture.

Additionally, known active domain controllers and other tier 1 resources (such as AD Connect servers or other authorities) may be cached in memory on a midserver to enable protection against chained attacks such as (for example, including but not limited to) DC Sync or DC Shadow type attacks. The cached list of tier 1 resources may be used to apply whitelist and blacklist functionality to these resources, which in turn may be used to provide a baseline level of protection through “default-blacklist” and other configurations that may be stored and applied using the cached list. This improves protection against these forms of attack without the need to configure rules for individual tier 1 resources, instead providing a rules-based approach that can be easily applied to changing lists of known and trusted resources.

In this example, a customer (business enterprise) virtual network 720 is established within the cloud computing service 710. The customer virtual network comprises a number of virtual machines 721a-n, operated on one or more of the cloud computing service 710 servers 722. Separately, a cloud-based service network is established on the cloud computing service 710 and is controlled by the cloud-based service 740 to which data is to be forwarded. Using the continuous streaming function available on the cloud computing service 710, for example vTAP for the Azure Active Directory service, a virtual machine on the cloud-based service network 730 is established as a virtual network peer VM 731 to the customer virtual network 720, and all data from the customer virtual network 720 is continuously streamed from the cloud computing service server(s) 722 to the virtual network peer VM 731, which forwards the data to the cloud-based service 740.

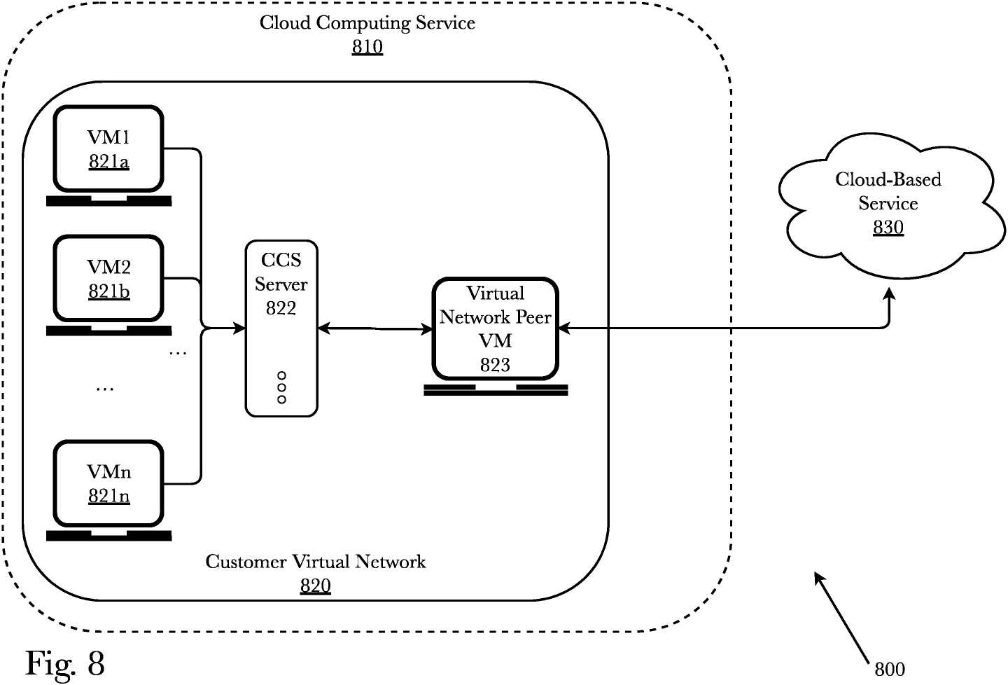

FIG. 8 is another exemplary method 800 for deploying a midserver where the business enterprise network is located on, or utilizes, a cloud computing service such as Amazon Web Services (AWS) or Microsoft’s Azure. In this example, a customer (business enterprise) virtual network 820 is established within the cloud computing service 810. The customer virtual network comprises a number of virtual machines 821a-n, operated on one or more of the cloud computing service 810 servers 822. The customer also operates on the customer virtual network 820 a virtual network peer VM 823 that is configured to aggregate and forward data to the cloud-based service 830, using the continuous streaming function available on the cloud computing service 810, for example vTAP for the Azure Active Directory service. In this manner, all data from the customer virtual network 820 is continuously streamed from the cloud computing service server(s) 822 to the virtual network peer VM 823, which forwards the data to the cloud-based service 830.

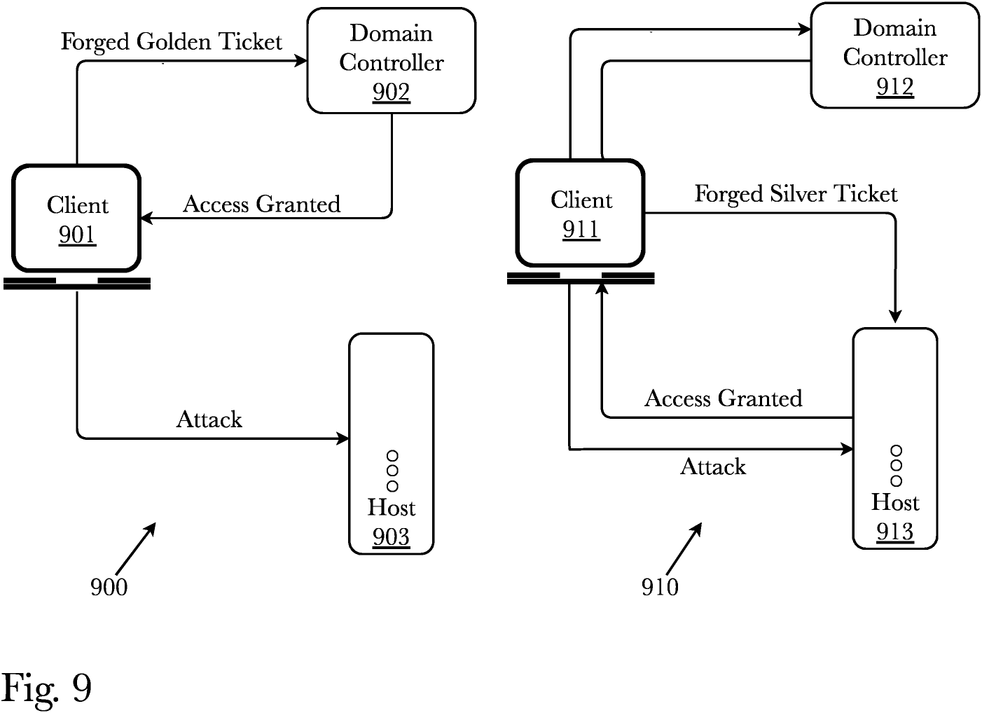

FIG. 9 is a diagram showing an overview of the methodology of two of several known Kerberos attacks. In the so-called “golden ticket” attack 900, after a client computer 901 has been compromised, a forged ticket is sent to the domain controller 902, which grants access to all servers in the network, and the host server 903 is accessed using the granted access. In the so-called “silver ticket” attack 910, after a client computer 911 has been compromised, a forged ticket granting service (TGS) ticket is sent directly to the host server 913 to be attacked. The host server receiving the forged TGS ticket grants access to the client computer 911 to grant access tickets, which are then used to access the host server 913. Unlike in the golden ticket attack, in the silver ticket attack, the domain controller 912 is not involved in granting access.

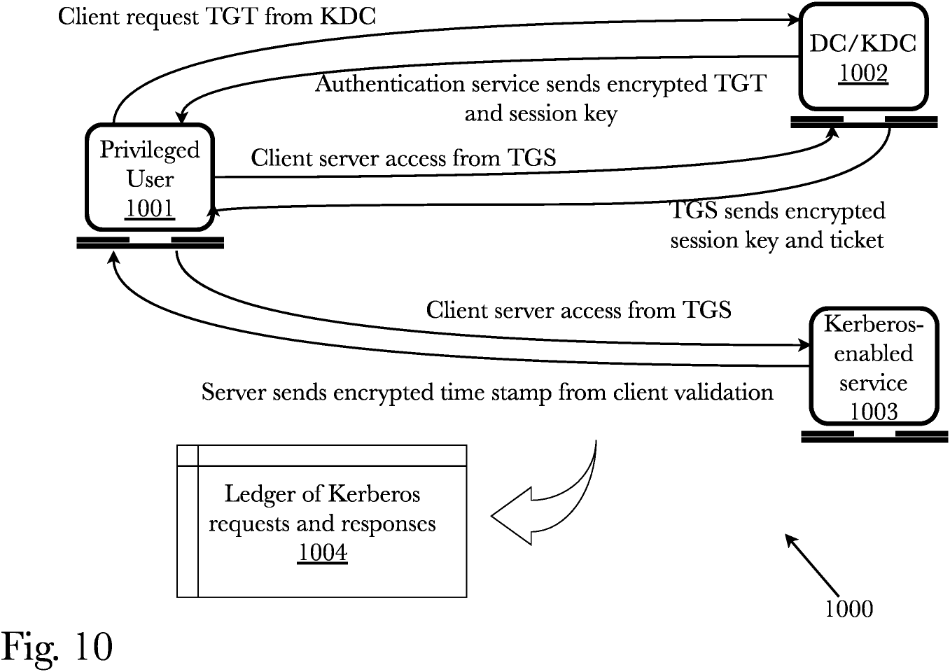

FIG. 10 is a diagram showing an overview of the use of a ledger of Kerberos requests and responses to provide security against Kerberos attacks 1000. In a typical Kerberos authentication interaction, several requests and responses are sent between a user computer 1001, a domain controller, 1002, and a Kerberos-enabled service 1003. Maintaining a ledger 1004 of these requests and responses effectively transforms the Kerberos protocol from a stateless to a stateful one, allowing confirmation of the validity of traffic and providing additional protection against Kerberos attacks.

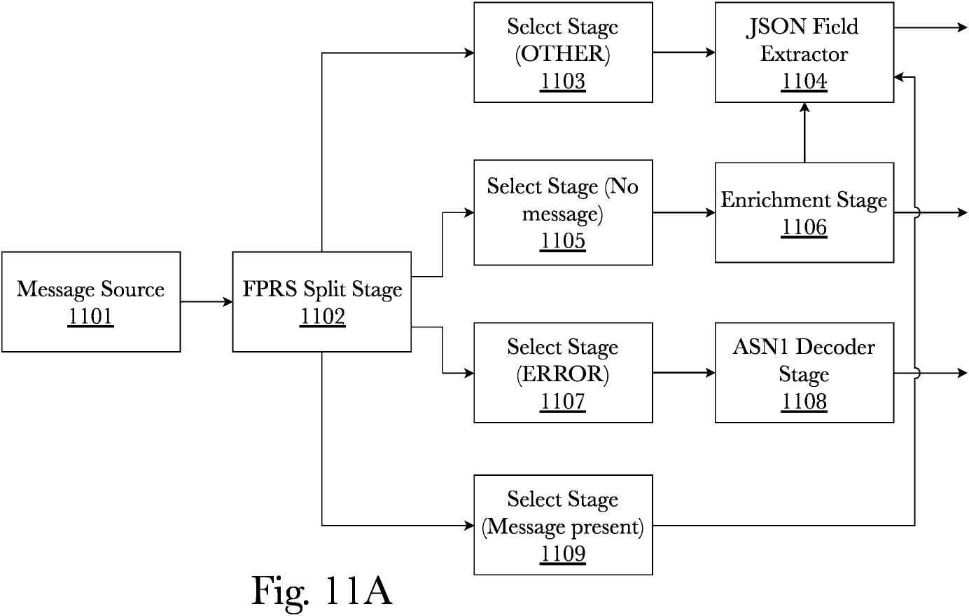

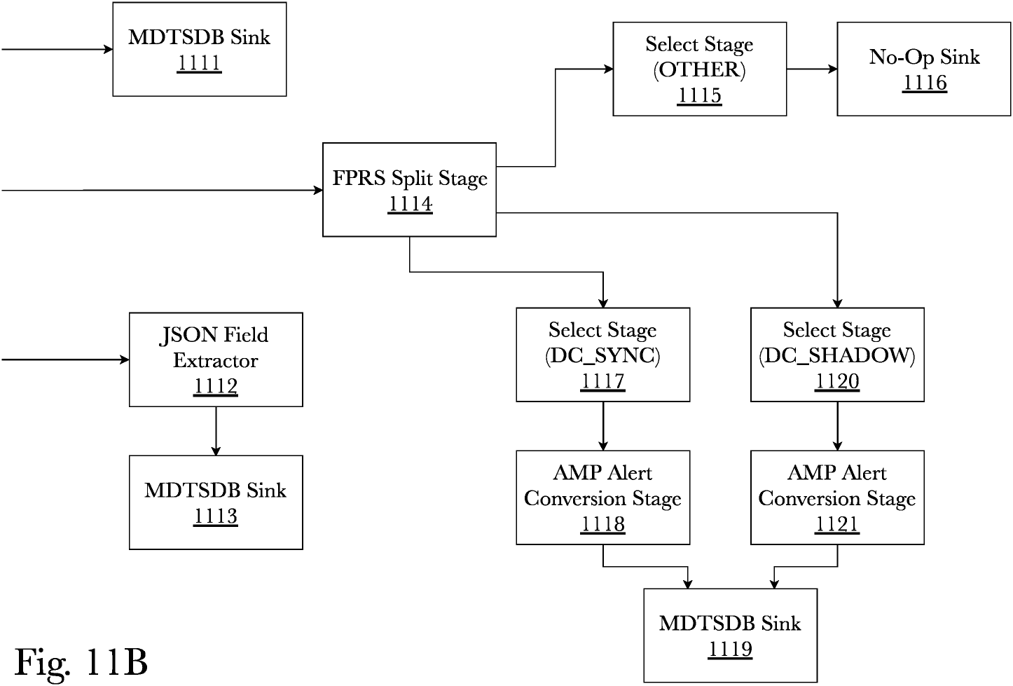

FIG. 11A is a partial diagram of a security analytic workflow validating an exemplary Kerberos ticket-based security protocol for use in an observed system in order to detect common attacks against the Kerberos protocol including those known by the industry as Golden Ticket, Silver Ticket, DCSync, and DCShadow. A messaging source 1101, such as RabbitMQ or NGINX, forwards received data messages to a FPRS split stage 1102, where specific message states are determined and separated to identify high priority tickets, and sent through appropriate processing pipelines. An “OTHER” stage 1103 represents unknown ticket priority and is forwarded to a JSON field extractor 1104 which extracts relevant data fields in Javascript Object Notation (JSON), which is a common data format for object representation in data analytics. A stage where no message is present 1105 represents a ticket with missing information, therefore being sent for an enrichment stage 1106 before being sent to a similar JSON field extractor 1104. An error stage 1107 may also be reached, resulting in the ticket being sent to an Abstract Syntax Notation One (ASN1) decoder 1108, ASN1 being a standard interface description language for defining data structures. If an otherwise normal message is present for a ticket stage 1109, it is sent directly for JSON field extraction 1104.

FIG. 11B is a partial diagram of a security analytic workflow validating an exemplary Kerberos ticket-based security protocol for use in an observed system in order to detect common attacks against the Kerberos protocol including those known by the industry as Golden Ticket, Silver Ticket, DCSync, and DCShadow. JSON field data that is extracted 1104 is then forwarded for being placed into a MDTSDB 1111, resulting in it being stored for later use in a temporal knowledge graph. After an error message is ASN1 decoded 1108, it is sent for JSON field extraction 1112, before also being recorded in a MDTSDB 1113. Once a no-message stage has been enriched 1106, it is sent to a secondary FPRS split stage 1114, where the enriched ticket is now determined to possess either an unknown or “OTHER” stage message 1115 and not stored anywhere 1116, or it has a DC_SYNC 1117 or DC_SHADOW 1120 message. In either of the latter two cases a the message is converted into an exemplary advanced malware protection (AMP) alert 1118, 1121 and stored in an MDTSDB 1119.

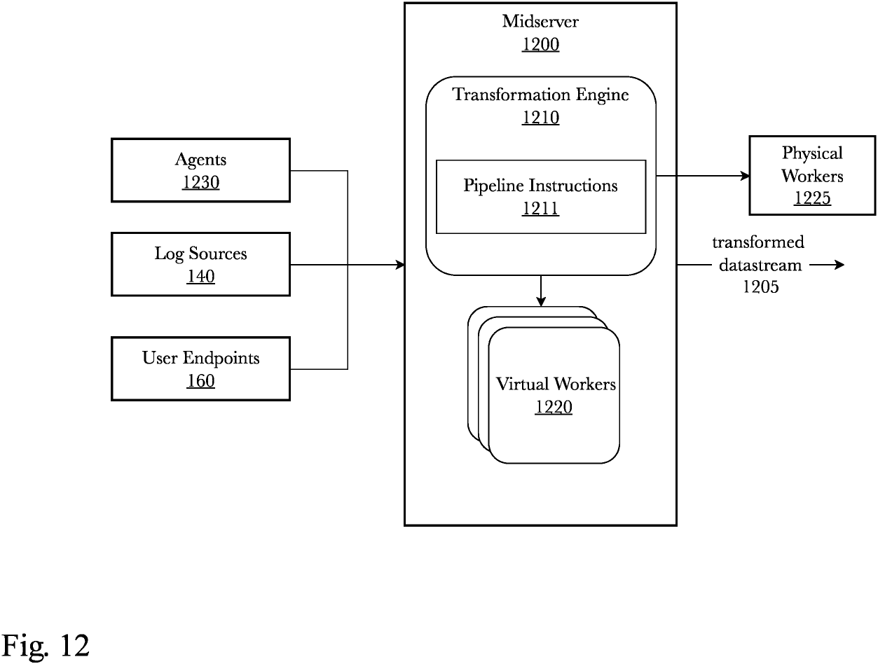

FIG. 12 is a block diagram illustrating an exemplary system architecture for a midserver configured for data stream transformation and processing, according to an embodiment. According to various embodiments, midserver 1200 is configured to receive a data stream from multiple sources. Exemplary sources can include, but are not limited to, agents 1230, log sources 140, and user endpoints 160. Agents 1230 may be instances of customer network monitoring agents 210 and/or agents 501-504, referring to FIG. 2 and FIG. 5A, respectively. At midserver 1200 a transformation engine 1210 is present and configured to receive a data stream from multiple sources, determine a target data stream format and/or content, determine a transformation sequence to be applied to the received data stream, break the data stream into one or more work units, and assign the work units for transformation by instantiating one or more virtual workers 1220 and/or physical workers 1225. Workers can be dynamically deployed based on the current data input load, based on a predetermined or real-time influenced schedule, or various other system state conditions that may or may not be present. A worker may refer to a service, a process, a plugin, an executable, and/or other software components. Worker 1220, 1225 may receive a data stream and begin processing the data for possible transformation before midserver 1200 routes the data to an appropriate endpoint.

Transformation engine 1210 is present and configured to receive a data stream or data batch from multiple sources. Transformation engine 1210 is configured to detect one or more individual target data stream formats and/or data type. Transformation engine 1210 can determine a target data stream format using various mechanisms including, but not limited to, based on destination system and/or service, based on intended use, based on data type, based on data transmission client, based on metadata (e.g., where each data element came from, when the data element was received, why it was sent, who sent (or last updated) the data, etc.), and/or the like.

In some implementations, the data type of the received data stream may also be determined when the data stream is received. Transformation engine 1210 can detect the data type using various methods such as, for example, based on the file format (e.g., file extension), analysis of the data stream (e.g., analysis of structure, pattern within the data stream, user input, (e.g., user indication that the data stream is a particular type), information (e.g., metadata) relating to the data stream, and/or other information.

Once a target data stream format has been determined, transformation engine 1210 may determine a transformation sequence (e.g., data transformation pipeline) to be applied to the received data stream. The transformation sequence may be referred to herein as pipeline instructions 1211 and represent the full set of transformations and the order in which they are to be applied for each data element of the data stream.

In some implementations, pipeline instructions 1211 can further comprise rules or conditions that determine how the data stream is to be configured to perform transformation such as, for example, by breaking the data stream into work units. As such pipeline instructions 1211 can further comprise already divided work units or rules for dividing the received data stream into one or more work units, and an indication of worker assignment for the work units. A work unit may be determined based on various methods. One method is based on the size of the work unit. An exemplary data stream can be divided into equal “chunks” (e.g., data blocks) for symmetric parallel processing. Alternatively, chunks could be sized according to available resources. For example, a low-memory machine can be used to process (e.g., transform) smaller chunks. Another method for creating work units is based on the type of transformation(s) needed. The pipeline instructions 1211 identify the transformations the data stream will undergo and this information can be leveraged to determine the size of the work unit. Yet another method of determining a work unit size can be based on the data source of the received data stream. The size of the work unit can be chosen and used for security policy enforcement associated with a data source. Likewise, midserver 1210 may have definable rules that indicate that all data from a particular source must be handled in a particular way or by a particular device.

In some embodiments, the build pipeline instructions 1211 are automatically scheduled at different times under the control of transformation engine 1210, which may implement algorithms and processes that described further in other sections. Furthermore, pipeline instructions 1211 may be executed according to a job specification (e.g., work unit size, worker assignment, etc.) that is generated by transformation engine 1210 or received via configuration data from other sources.

Pipeline instruction 1211 may correspond to a pipeline of transformation associated with the target data stream format and/or the data stream data type. The pipeline of transformations may be defined by one or more template specifications. The pipeline instructions 1211 may identify the transformations and the order in which they are to be performed. The pipeline instructions 1211 may identify other data to be used in one or more of the transformations (e.g., data to be integrated with/into the data stream). The pipeline instructions 1211 may enable dynamic selection of options for one or more transformations. In various implementations, the pipeline instructions 1211 may include one or more serial transformations, parallel transformations, one or more join operations, and/or other transformations. Serial transformations may refer to transformations that are performed in a sequence. Parallel transformations may refer to transformations that are performed simultaneously or overlapping in time.

Once the data stream has been divided into appropriate work units, transformation engine 1210 may then assign the work units for transformation. Work units can be assigned to one or more virtual workers 1220 within midserver 1200 and/or physical workers 1225 (i.e., other devices on the network). The workers may receive pipeline instructions 1211 from transformation engine 1210 and create a data transformation pipeline which receives one or more work units and outputs transformed data work units. Transformation of the data stream comprising one or more work units may include applying a set of operations (as defined by pipeline instructions 1211) to the data stream. An operation can include one or more data transformations. Data transformations can include data extraction, data processing, data integration (e.g., with other data), and data manipulation (e.g., language/mathematical operations, deduping operations, etc.), to provide some non-limiting examples. In some embodiments, transformation engine 1210 may store results of applying the set of operations to the data stream/work units (e.g., the transformed data) based on completion of all operations within the pipeline instructions 1211. Such storage of transformed data streams may ensure data consistency.

Transformation engine 1210 preferably maintains a queue of work units from which the workers 1220, 1225 obtain the next available work unit. While a variety of scheduling algorithms can be used that are well known in the art, a simple first-in-first-out scheme may be utilized in a preferred embodiment.

The transformed work unit as output by each worker’s data transformation pipeline can be appended to a new singular data stream 1205 for transmission to the appropriate endpoint. For example, the transformed data stream may be sent to MDTSDB service 556 or DCG 554, referring to FIG. 5C.

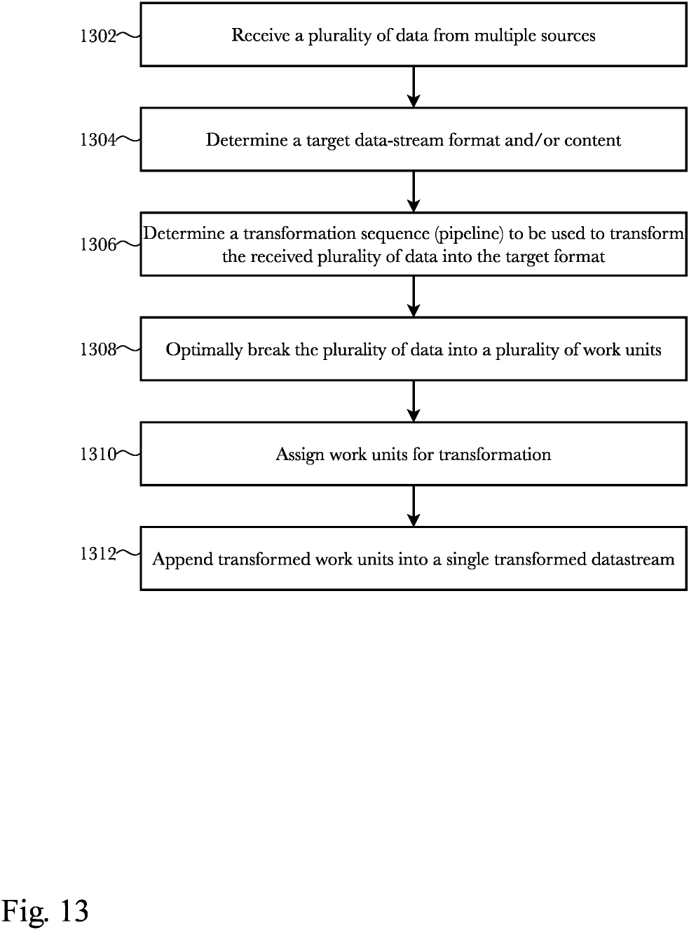

FIG. 13 is a flow diagram illustrating an exemplary method performing a data stream transformation using midserver system, according to an embodiment. According to the embodiment, the process begins at 1302 when transformation engine 1210 receives, retrieves, or otherwise obtains a plurality of data from multiple sources. For example, multiple sources may include network monitoring agents 1230, user endpoints 160, and log sources 140. At 1304 the system determines a target data stream format and/or content for one or more subsets of the obtained plurality of data. There are various mechanisms that can be used to determine a target data stream and can vary according to the implementation of the method. For example, the target format may be determined based on destination system and/or service or based on intended use. In some embodiments, the received data may be formatted to drop unnecessary data to conserve bandwidth. In some implementations, the target format may be determined based on analysis of available metadata such as, for example, metadata describing where each data element of the plurality of data came from, metadata describing when the data element was received and/or created, metadata describing the provenance of the data element, metadata that describes how the data element was generated, temporal metadata, and/or other metadata which describes properties of the data element.

In some implementations, transformation engine 1210 determines a data type associated with the received data stream. The determined data type of the received data stream can then be used to assist in the determination of the a target data stream format.

At 1306 the system can determine a transformation sequence to be used to transform the received plurality of data into the target format. The transformation sequence may be implemented utilizing one or more data transformation pipelines specifically configured for a data element and/or a work unit. The transformation sequence may identify the transformation(s) needed for each data element and to identify the order in which they need to be applied. In some implementations, each transformation pipeline comprises at least a first dataset and/or data stream, a first transformation, a second derived dataset and dataset dependency and timing metadata. In some embodiments, the transformation pipelines are capable of executing serial or serial-parallel transformations on data streams. The data stream may be transformed based on an identified data (e.g., file type) type. The transformations may include applying a set of configurations to the data stream, dataset, data chunk, etc., wherein the set of configurations can correspond to a pipeline of transformations associated with the identified data type. In some implementations, the identified data type may be the determined target data type (i.e., data format).

The transformations may comprise any operation that transforms columns or data of a first dataset to columns or data of a second and/or derived dataset. The first dataset may be a raw dataset or a derived dataset. The transformations may comprise, for example, creating the derived dataset without a column that is in the raw dataset, creating the derived dataset with a column that is in the raw dataset and using a different name of the column of the derived dataset, performing calculations that change data or add columns with different data, filtering, sorting or any other useful transformation. Further, a transformation may comprise transforming a dataset into a format appropriate for a determined target data stream format and/or content.

At 1308 transformation engine 1210 of midserver 1200 breaks the data stream down into a plurality of work units. The work units can be broken down based on a variety of factors such as, for example, the size of the unit, the type of transformation needed, the source of the data, policy and/or rules, and/or the like. Work units may be based on size such that a data stream can be divided into equal “chunks” for symmetric parallel processing. Alternatively, chunks can be size according to the available resources (e.g., available compute nodes such as virtual workers 1220 and physical workers 1225. Each work unit is designed to be independent of other work units in the data stream.

At 1310 transformation engine 1210 assigns work units for transformation. In some embodiments, work units can be assigned to virtual workers 1220 within midserver 1200. Transformation engine 1210 can instantiate X amount of virtual workers, assign Y work units to each worker, schedule execution to avoid resource conflicts, and append each completed work unit to a new singular data stream for transmission.

In some embodiments, work units can be assigned to physical workers 1225, i.e., other devices on the network. Work units may be assigned to physical workers based on policy or business rules. For example, security enforcement for policy compliance may be considered when assigning work units. Work units may be assigned to physical workers bas on transformation type such as a certain device used for specific transformations, for example to utilize unique hardware. For example, some devices may comprise ray-tracing cores on specific GPU models for a certain type of transformation. Work units can be assigned to physical workers based on device resources. Load balancing (e.g., utilizing a specific amount of each machine) and hardware advantages (e.g., ray-trace cores, CUDA cores, massively-parallel coprocessors, etc.) may be considered when analyzing device resources.

As a last step 1312, the workers 1220, 1225 return the transformed work units to transformation engine 1210 which can then append the received work units into a single transformed data stream that can be transmitted to the appropriate target destination (e.g., network endpoint, cloud-based service 740, 830, and/or advanced cyber-decision platform.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

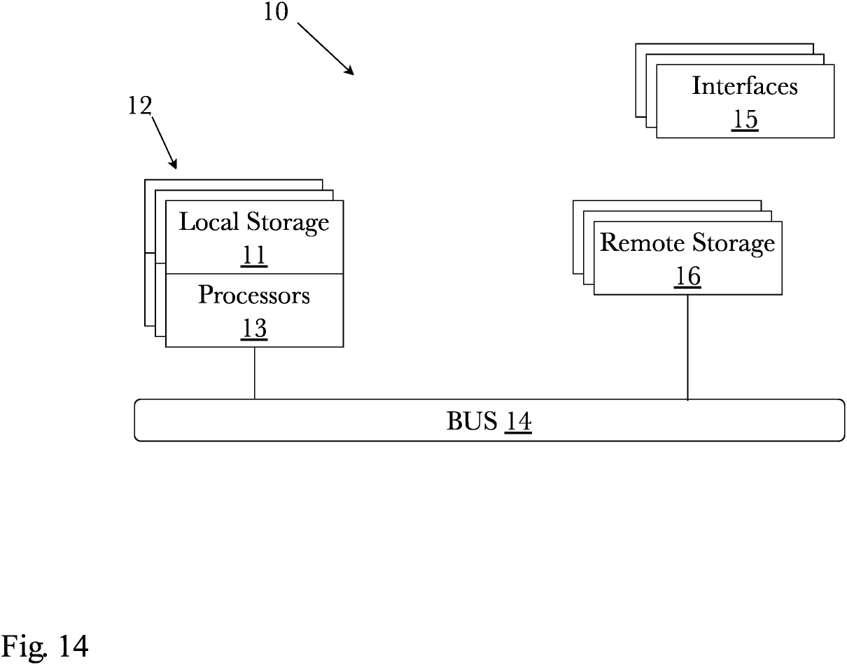

Referring now to FIG. 14, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 14 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD- ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

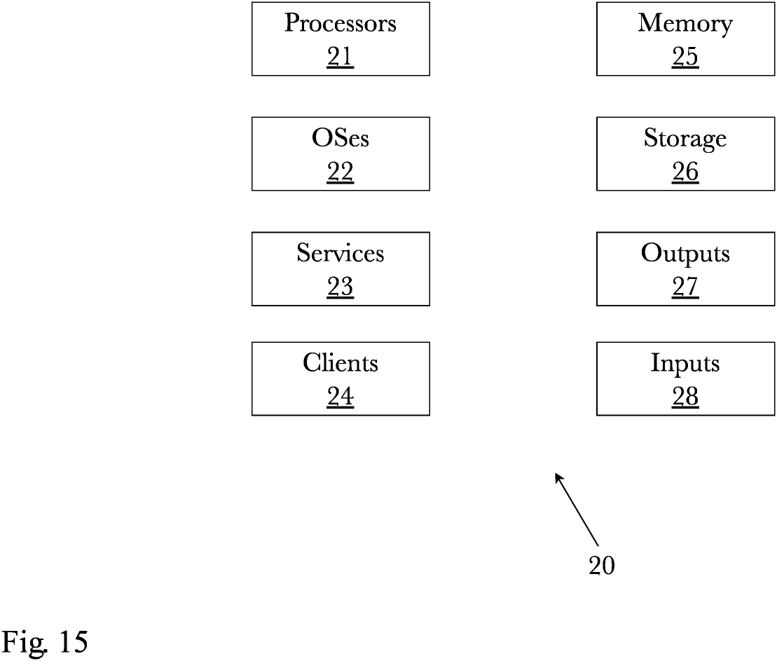

In some embodiments, systems according to the present invention may be implemented on a standalone computing system. Referring now to FIG. 15, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 14). Examples of storage devices 26 include flash memory, magnetic hard drive, CD-ROM, and/or the like.

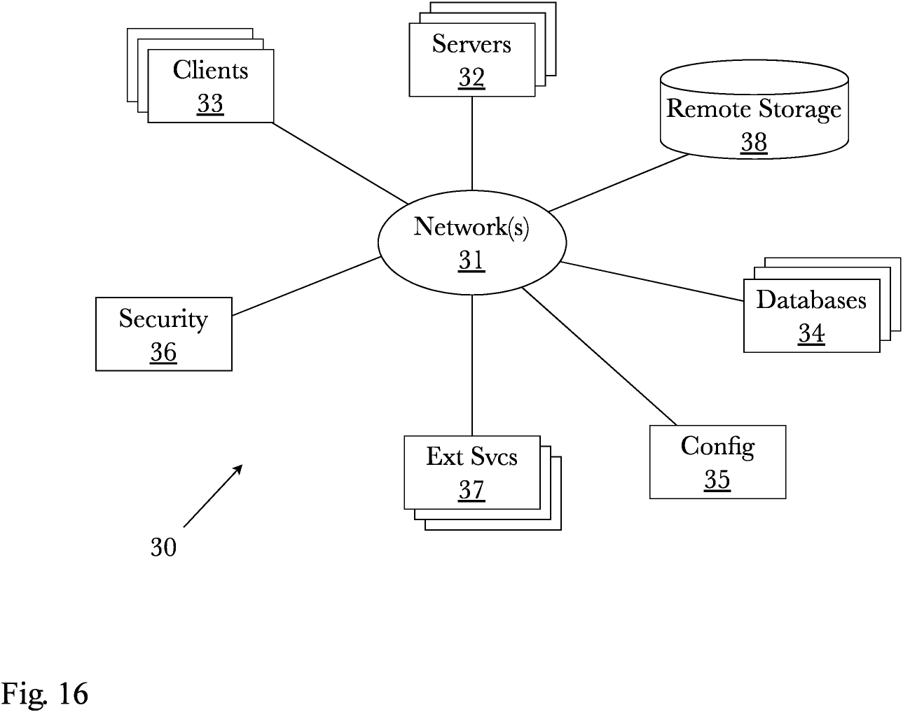

In some embodiments, systems of the present invention may be implemented on a distributed computing network, such as one having any number of clients and/or servers. Referring now to FIG. 16, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 15. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise’s or user’s premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

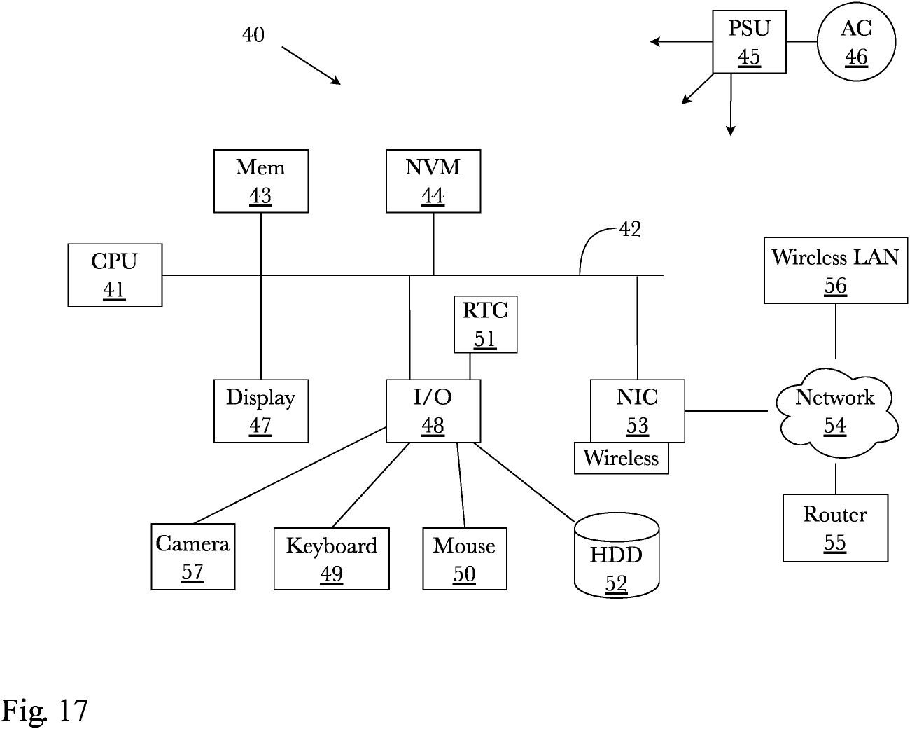

FIG. 17 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for ingestion and transformation of data into a cloud-based service from an external network, comprising:
a midserver comprising at least a processor, a memory, and a plurality of programming instructions stored in the memory and operating on the processor, wherein the plurality of programming instructions, when operating on the processor, cause the processor to:
receive a data stream over a local network from a plurality of computing devices;
determine a target data stream format;
determine a transformation sequence for the received data stream based at least on the determined target data stream format;
break the data stream into one or more work units;
assign the one or more work units to a worker agent for transformation;
wherein the worker agent is configured to:
for each work unit, apply a plurality of transformations to at least a portion of the work unit; and
return each transformed work unit;
append each transformed work unit into a single transformed data stream; and retransmit the received data stream over a secure connection as a single transformed data stream.

2. The system of claim 1, wherein the determination of the target data stream format is based at least on a destination system or service, on an intended use, or based on metadata.

3. The system of claim 2, wherein the metadata includes at least an indication of where each data element of the data stream came from and an indication of when each data element was received.

4. The system of claim 1, wherein the transformation sequence identifies one or more transformations needed for each data element of the received data stream and identifies the order in which the one or more transformations need to be performed.

5. The system of claim 1, wherein the work units are divided by selecting from the group consisting of based on unit size, based on type of transformation needed, and based on data source attributes.

6. The system of claim 1, wherein the worker agent is a virtual agent operating within the midserver.

7. The system of claim 1, wherein the worker agent is a physical agent operating on a network device separate from the midserver.

8. The system of claim 1, wherein the worker agent comprise both virtual agents and physical agents.

9. A method for ingestion and transformation of data into a cloud-based service from an external network, comprising the steps of:
receiving a data stream over a local network from a plurality of computing devices;
determining a target data stream format;
determining a transformation sequence for the received data stream based at least on the determined target data stream format;
breaking the data stream into one or more work units;
assigning the one or more work units to a worker agent for transformation;
wherein the worker agent is configured to perform the steps of:
for each work unit, applying a plurality of transformations to at least a portion of the work unit;
returning each transformed work unit;
appending each transformed work unit into a single transformed data stream; and
retransmitting the received data stream over a secure connection as a single transformed data stream.

10. The method of claim 9, wherein the determination of the target data stream format is based at least on a destination system or service, on an intended use, or based on metadata.

11. The method of claim 10, wherein the metadata includes at least an indication of where each data element of the data stream came from and an indication of when each data element was received.

12. The method of claim 9, wherein the transformation sequence identifies one or more transformations needed for each data element of the received data stream and identifies the order in which the one or more transformations need to be performed.

13. The method of claim 9, wherein the work units are divided by selecting from the group consisting of based on unit size, based on type of transformation needed, and based on data source attributes.

14. The method of claim 9, wherein the worker agent is a virtual agent operating within the midserver.

15. The method of claim 9, wherein the worker agent is a physical agent operating on a network device separate from the midserver.

16. The method of claim 9, wherein the worker agent comprise both virtual agents and physical agents.
